(19) United States
(12) Patent Application Publication
(10) Pub. No.: US 2011/0148174 A1
(43) Pub. Date: Jun. 23, 2011

(54) STRUCTURAL PART AND VEHICLE SEAT COMPRISING A BACK REST

(75) Inventors: Dirk Eckenroth, Bergisch-Gladbach (DE); Holger Robkes, Solingen (DE)

(73) Assignee: Johnson Control Technology Company, Holland, MI (US)

(21) Appl. No.: 12/989,071

(22) PCT Filed: Apr. 22, 2009
(86) PCT No.: PCT/EP2009/002929

§ 371 Date: Feb. 22, 2011

(30) Foreign Application Priority Data
Apr. 22, 2008 (DE) 10 2008 020 290.8

(51) Int. Cl. B60N 2/68

(52) U.S. Cl. 297/452.18

(57) ABSTRACT

A structural part, such as for a vehicle seat, has at least one panel element, a reinforcement frame, and a reinforcement element. The reinforcement frame has at least one first profile element and one second profile element. The reinforcement frame runs substantially along an edge of the panel element. The reinforcement element is at least partially within a plane of the reinforcement frame, and is connected only to the first profile element and to the panel element.

### CROSS REFERENCE TO RELATED APPLICATIONS

This application claims priority from and the benefit of PCT Application No. PCT/EP2009/002929, filed on Apr. 22, 2009; and German Patent DE 10 2008 020 290.8, filed on Apr. 22, 2008; all entitled “Structural Part and Vehicle Seat Comprising a Back Rest”, which are herein incorporated by reference.

### BACKGROUND

The present invention relates to a structural part and to a vehicle seat having a backrest.

Backrests for vehicle seats are generally known. For example, documents DE 10 2006 036 935 A1 and DE 10 2005 043 084 A1 disclose, respectively, a backrest for a seat bench of a vehicle and a construction set for producing a tiltable backrest for a seat bench of a vehicle. Here, to reinforce the backrest for the absorption of forces which may occur on account of a safety belt arranged in the region of the backrest of a rear seat bench, use is made of continuous profile parts or reinforcement elements which fully traverse a frame produced for example from profile parts, that is to say are fastened to a plurality of frame limbs or profile parts. The reinforcement elements used here are however comparatively large and heavy, resulting firstly in high cost expenditure and secondly in a high weight of a backrest of said type.

Therefore, the present invention is based on the object of specifying a structural part, in particular for a backrest of a vehicle seat, and a vehicle seat having a backrest, in particular for a rear seat bench of a vehicle, such that a reinforcement element, in particular for absorbing belt forces, can be formed to be considerably lighter and therefore also cheaper, and nevertheless a high level of safety is ensured for the occupants of the motor vehicle.

### SUMMARY

The object is achieved by means of a structural part, in particular for the backrest of a vehicle seat, with the structural part having at least one panel element and also having a reinforcement frame which has at least one first profile element and one second profile element and which runs substantially along the edge of the panel element, with a reinforcement element being provided at least partially within the plane of the reinforcement frame, and also with the reinforcement element being connected only to the first profile element and to the panel element. According to the invention, a particular advantage is attained in that particularly simple and fast production of the structural part is possible as a result of a connection only to one of the profile elements which form the frame. The object is also achieved by means of a vehicle seat, in particular rear seat bench of a vehicle, having a backrest and if appropriate having a seat part, with the backrest and/or the seat part having at least one structural part according to the invention.

It is very particularly preferable according to the invention for the reinforcement element to be provided for connecting a belt retractor of a safety belt, with a belt deflecting device which is assigned to the belt retractor being connected to the first profile element and/or to the reinforcement element, or it is preferable for the reinforcement element to extend, in the region of the first profile element, over 30% to 80% of the extent of the first profile element, preferably over 40% to 70% of the extent of the first profile element, particularly preferably over 45% to 65% of the extent of the first profile element, very particularly preferably over 50% to 60% of the extent of the first profile element. In this way, it is particularly advantageously possible for an introduction of belt forces, or of forces arising from the connection of belt fastening components, into the frame or into the reinforcement frame produced from the profile elements to be possible in such a way that, firstly, the loading is distributed over a comparatively large area, and secondly, the panel element can also be incorporated in a substantial way for absorbing stresses. In this way, it is very advantageously possible according to the invention for the actual reinforcement element for connecting for example a belt retractor to be produced in a comparatively lightweight and cheap form, and to thereby also contribute less to the overall weight of the vehicle seat or backrest.

It is very particularly preferable according to the present invention for the first and/or second profile element to be connected at least partially by means of a butt weld to the panel element. This means in particular that for example a limb of one of the profile elements is connected with its edge (which runs along the profile part and which has substantially only the surface area of the material thickness multiplied by the length of the edges) to the surface of the panel element by means of a welding operation. It is also preferable according to the invention for said type of welding to be carried out by means of a laser (laser welding), with the laser beam being applied from that side of the panel element which faces away from the profile element (to be welded). It is also preferable according to the invention for the reinforcement element to be connected to the panel element and/or to the reinforcement frame by means of laser welding.

It is also preferable according to the invention for the first and/or second profile element to be provided as a U-shaped profile and/or a C-shaped profile and/or a Z-shaped profile, wherein in cross section, the limb end or limb ends of the first and/or second profile element are preferably provided without fastening lugs. The invention however does not completely rule out that the first and/or second profile element may (also) have lugs. According to the invention, it is particularly preferable for the first and/or second profile element to have a shape or a cross section which is such that, after the connection to the panel element, a hollow profile is formed which has a comparatively high degree of stability. According to the invention, U-shaped profiles or C-shaped profiles in particular (which in cross section have an open side which is closed, so as form a hollow profile, as a result of the connection to the panel element) are suitable for this purpose. According to the invention, it is however also possible for the first and/or the second profile element to be designed as an L-shaped profile or as a Z-shaped profile. It is possible even with a profile element of said type, in particular together with a deformed edge of the panel element, for a hollow profile to be generated (after assembly).

It is provided according to the invention in particular that the profile elements together form either a closed (in particular substantially tetragonal or rectangular) reinforcement frame or else merely a U-shaped arrangement on the panel element. To realize a completely closed frame, it is provided according to the invention in particular that four profile elements (the first and second profile elements together with a third and a fourth profile element) are provided, with each profile element being connected firstly to the panel element and with each profile element secondly being connected to two of the other profile elements so as to form the frame.

According to the invention, it may likewise be provided that more than four profile elements are used to complete the frame; in particular, it may also be provided according to the invention that corner pieces or corner profile elements are provided in the corner regions of the frame.

### DRAWINGS

Exemplary embodiments of the invention are illustrated in the drawing and will be explained in more detail in the following description.

FIG. 1 schematically shows a side view of a vehicle seat having a backrest.

FIGS. 2 and 5 schematically show in each case one structural part according to the invention, for example for use in the backrest of a vehicle seat.

FIGS. 3 and 6 schematically show in each case one reinforcement element in a perspective illustration.

FIG. 4 schematically shows a structural part known from the prior art.

### DETAILED DESCRIPTION

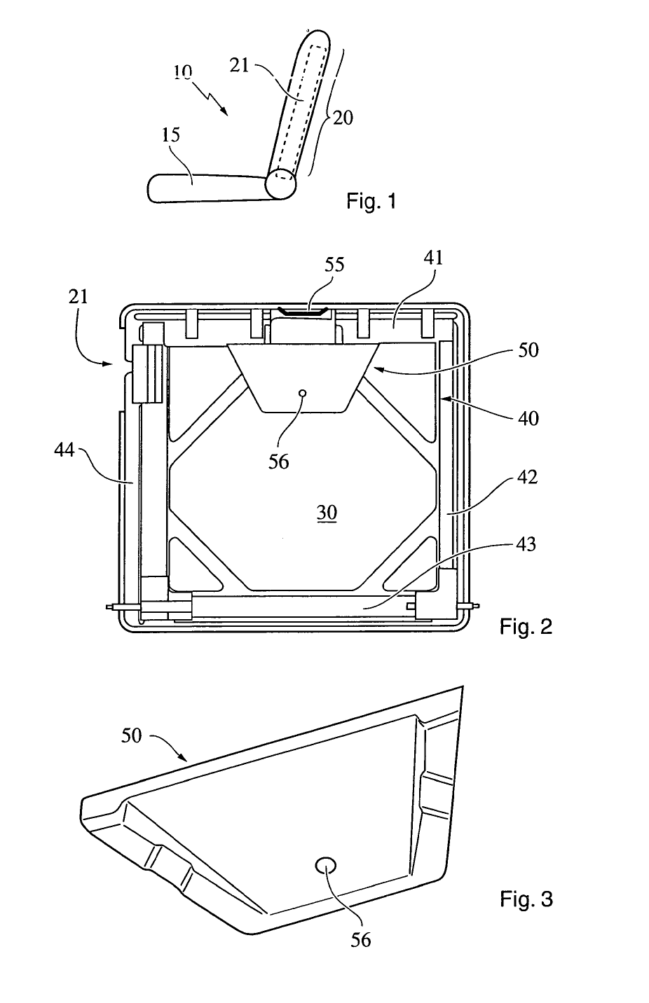

FIG. 1 schematically shows a side view of a vehicle seat 10 according to the invention having a backrest 20 and having a seat part 15. In the example illustrated, the backrest 20 has a structural part 21 according to the invention, which is indicated schematically by means of a dashed line.

According to FIG. 2 and FIG. 5, the structural part 21 has a panel element 30 and a reinforcement frame 40 which comprises for example a first profile element 41, a second profile element 42, a third profile element 43 and a fourth profile element 44. The structural part 21 is illustrated schematically in a plan view in FIG. 2, while said structural part 21 is depicted schematically in a perspective illustration in FIG. 5. In the illustrated example, the profile elements 41, 42, 43, 44 form a substantially fully encircling frame on a side of the structural part 21, which frame is for example of tetragonal design. The profile elements 41, 42, 43, 44 are in particular welded to one another in corner regions of the reinforcement frame 40. Furthermore, the profile elements 41, 42, 43, 44 are welded to the panel element 30. To reinforce the reinforcement frame 40, a reinforcement element 50 is provided. According to the invention, the reinforcement element 50 serves in particular to be able to absorb forces which originate from a belt retractor or which act between a belt retractor and a belt deflecting device. The connecting point or connecting location for a belt retractor is denoted in FIG. 2 and FIG. 5 by the reference numeral 56. The belt deflecting device is denoted by the reference numeral 55. The forces introduced by the reinforcement element in particular into the reinforcement frame 40 are distributed (spatially) over a comparatively large area, such that the overall arrangement has a high load bearing capacity (in relation to the weight of the reinforcement element 50). For example, it is possible for comparatively low material thicknesses to be used for the reinforcement element 50. This results in a relatively significant deformation under load (in particular in the event of an accident). On account of the relatively significant deformation, a relatively large proportion of the load to be absorbed is in turn accommodated via the panel element 30, and thereby also introduced more uniformly into the reinforcement frame 40.

Also illustrated in FIG. 2 and FIG. 5, in addition to the reinforcement element 50, the belt deflecting device 55 and the connecting location 56 for a belt retractor, are a connecting location 57 for a side lock (in particular for fastening or locking the backrest 20 to a vehicle chassis or the vehicle body) and also a pivot axle 58 (in particular for enabling the backrest 20 to pivot relative to the vehicle body (for example in order to create a larger luggage compartment volume)).

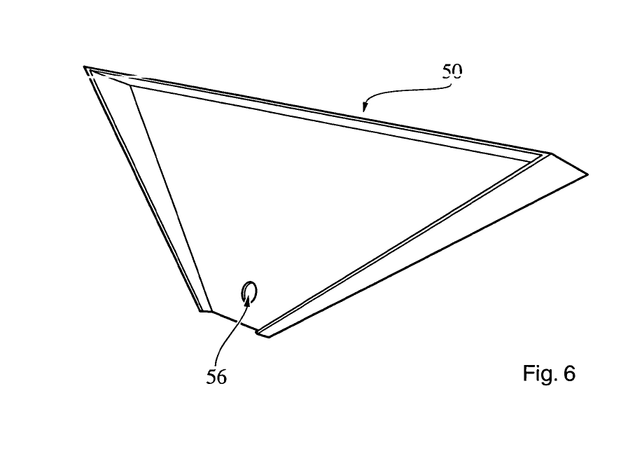

FIG. 3 and FIG. 6 each schematically show a perspective illustration of a reinforcement element 50, with a connecting location 56 for a belt retractor being indicated (but without the belt retractor being illustrated).

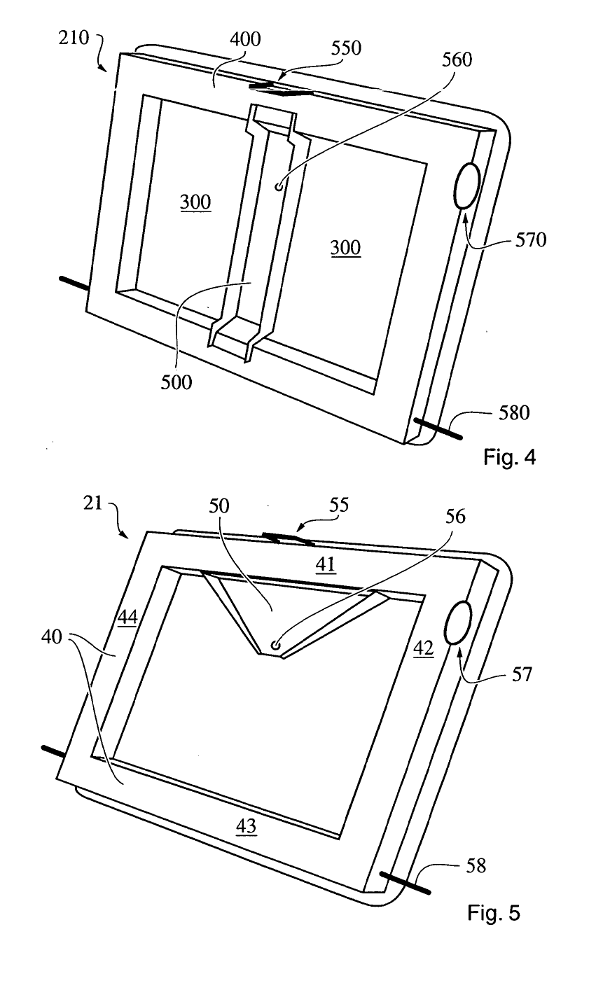

FIG. 4 illustrates a structural part 210 as known from the prior art. The known structural part 210 has a known panel element 300 and a known reinforcement frame 400. FIG. 4 shows the known structural part 210 schematically in a perspective illustration. To reinforce the known reinforcement frame 400, a known reinforcement element 500 is provided, which spans the entire clear width of the known reinforcement frame 400 and is connected to at least two sides of the known reinforcement frame 400 (and therefore also to at least two profile elements (not illustrated in detail) of the known reinforcement frame 400). The known reinforcement element 500 serves to be able to absorb forces which originate from a belt retractor or which act between a belt retractor and a known belt deflecting device. The connecting location for a belt retractor is denoted in FIG. 4 by the reference numeral 560. The known belt deflecting device is denoted by the reference numeral 550. Also illustrated in FIG. 4, in addition to the known reinforcement element 500, are a known connecting location 570 for a side lock and also a known pivot axle 580. The introduction of force from the known reinforcement element 500 into the known reinforcement frame 400 is spatially more intensely concentrated than is the case in the design of the reinforcement element 50 or structural part 21 according to the invention, for example according to FIGS. 2, 3, 5 and 6, such that (for the same load bearing capacity) it is necessary to use for example greater material thicknesses in the known structural part 210.

### LIST OF REFERENCE NUMERALS

10 Vehicle seat

15 Seat part

20 Backrest

21 Structural part

30 Panel element

40 Reinforcement frame

41 First profile element

42 Second profile element

43 Third profile element

44 Fourth profile element

50 Reinforcement element

55 Belt deflecting device

56 Connecting location for a belt retractor

57 Connecting location for a side lock

58 Pivot axle

210 Known structural part

300 Known panel element

400 Known reinforcement frame

500 Known reinforcement element

550 Known belt deflecting device

560 Known connecting location for a belt retractor

570 Known connecting location for a side lock

580 Known pivot axle

1. A structural part, in particular for the backrest of a vehicle seat, comprising at least one panel element, a reinforcement frame which has at least one first profile element, and one second profile element and which runs substantially along an edge of the panel element, and a reinforcement element being provided at least partially within a plane of the reinforcement frame, wherein the reinforcement element is connected only to the first profile element and to the panel element.

2. The structural part as claimed in claim 1, wherein the reinforcement element extends, in the region of the first profile element, over 30% to 80% of the extent of the first profile element.

3. The structural part as claimed in claim 1, wherein the reinforcement element is configured to be connected to a belt retractor of a safety belt, and wherein a belt deflecting device of the belt retractor is connected to the first profile element.

4. The structural part as claimed in claim 1, wherein the first and/or second profile element is connected at least partially by means of a butt weld to the panel element.

5. The structural part as claimed in claim 1, wherein the first and/or second profile element is provided as a U-shaped profile and/or a C-shaped profile and/or a Z-shaped profile.

6. The structural part as claimed in claim 1, wherein the first profile element and the second profile element are connected to one another and also to the panel element by, in each case a laser welding operation.

7. A vehicle seat comprising a backrest and/or a seat part, wherein the backrest and/or the seat part has at least one structural part as claimed in claim 1.

8. The structural part as claimed in claim 1, wherein the reinforcement element extends, in the region of the first element, over 40% to 70% of the extent of the first profile element.

9. The structural part as claimed in claim 1, wherein the reinforcement element extends, in the region of the first element, over 45% to 65% of the extent of the first profile element.

10. The structural part as claimed in claim 1, wherein the reinforcement element extends, in the region of the first element, over 50% to 60% of the extent of the first profile element.

11. The structural part as claimed in claim 5, wherein in cross section, a limb end or limb ends of the first and/or second profile element are provided without fastening lugs.

12. The vehicle seat as claimed in claim 7, wherein the vehicle seat comprises a rear seat bench of a vehicle.
